(19) United States
(12) Patent Application Publication
(10) Pub. No.: US 2008/0125978 A1
(43) Pub. Date: May 29, 2008

(54) Method and apparatus for deriving the genome of an individual

(75) Inventors: Barry Robson, Bronxville, NY (US); Richard Mushlin, Ridgefield, CT (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 10/269,150

(22) Filed: Oct. 11, 2002

(51) Int. Cl. G06F 19/00

(52) U.S. Cl. 702/20

(57) ABSTRACT

A computer-based method is provided for deriving a genome of an individual. The method comprises the steps of accessing a selector for an individual and a reference template for a group genome, the selector comprising a locus value and a base value; and processing the selector and the reference template to derive a sequence representative of the genome of the individual. The reference template preferably comprises data components representing a probability of occurrence of a base value. The probability of occurrence is based on base value occurrences at corresponding locus values in the group genome. The method of the present invention further comprises computing a base value from the data component in the reference template, for base values not in the selector.

### FIELD OF THE INVENTION

The present invention relates to the electronic transmission of data and, more particularly, to a computer-based method for expressing a genome of an individual.

### BACKGROUND OF THE INVENTION

Sequencing the human genome and other recent advances in the field of bioinformatics suggest that the medicine of the future will take advantage of genomic data. For example, researchers and health care providers anticipate the ability to design drugs or screen a variety of drugs based upon the drugs' ability to bind to a protein coding for a patient's gene sequence. In addition, the Internet is already widely used to obtain medical information. Medical data are among the most retrieved information over the Internet. With a projection of one billion individuals on the Internet by the year 2005, new challenges will be presented to efficiently transport such volumes of genomic data. Computers and the Internet are also being utilized more and more frequently for data mining of genomic sequences. This increased volume of transmissions involving genomic data will demand more efficient ways to forward genomic information and other information related thereto.

The transmission of the genomic data of an individual is difficult because of the large amount of data present. Conventional methods of electronically transmitting genomic data are unnecessarily slow and more prone to errors and unauthorized access. Errors occurring in the transmission of an individual's genomic data can have dire consequences, especially if used in medical treatments. Thus, there exists the need for an efficient and accurate method of genome transmission.

### SUMMARY OF THE INVENTION

The present invention provides solutions to the needs outlined above, and others, by providing improved expression of a genome of an individual.

Disclosed herein is a method for deriving a genome of an individual. The method comprises the steps of accessing a selector for an individual and a reference template for a group genome, the selector comprising a locus value and a base value; and processing the selector and the reference template to derive a sequence representative of the genome of the individual.

The reference template preferably comprises data components representing a probability of occurrence of a base value. The probability of occurrence is based on base value occurrences at corresponding locus values in the group genome. The method of the present invention further comprises the step of computing a base value from the data components in the reference template, for base values not in the selector.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary genomic messaging system (GMS);

FIG. 2 is a block diagram of an exemplary hardware implementation of a GMS;

FIG. 3 is a flow chart illustrating an overall method for deriving a genome of an individual;

FIG. 4 is a flow chart illustrating the processing of a selector;

FIG. 5 is a flow chart illustrating the processing of a reference template; and

FIG. 6 is a flow chart illustrating the computation of a base value from a reference template.

### DETAILED DESCRIPTION OF PREFERRED EMBODIMENTS

The present invention will be illustrated below in the context of an illustrative genomic messaging system (GMS). In the illustrative embodiment, the invention relates to the expression of DNA sequence data. However, it is to be understood that the present invention is not limited to such a particular application and can be applied to other data relating to a genome including, for example, RNA sequences.

The GMS relates to software in the emergent field of clinical bioinformatics, i.e., clinical genomics information technology (IT) concentrating on the specific genetic constitution of the patient, and its relationship to health and disease states. Clinical bioinformatics is distinct from conventional bioinformatics in that clinical bioinformatics concerns the genomics and the clinical record of the individual patient, as well as that of the collective patient population. Thus, there are not only medical research applications which could benefit from the invention, but also healthcare IT applications, such as those in the category of e-health.

The clinical application of genomics and bioinformatics requires special consideration for the privacy of the patient (see, e.g., George J. Annas, “A National Bill of Patients' Rights,” in “The Nation's Health,” 6th edition, eds. P. R. Lee & C. L. Estes, Jones and Bartlett Publishers, Inc., 2001), the safety of the patient and for the production of informed decisions by the patient and the physician. The federal Health Insurance Portability and Accountability Act (HIPPA) has been recently introduced to enforce the privacy of online medical data. HIPPA addresses transmitting, storing or manipulating patient genomic data.

Since the system of the invention may be involved in a variety of medical care scenarios, including emergency medical care, it has been designed to be minimally dependent on other systems. The messaging network can include direct communication between laptop computers or other portable devices, without a server, and even the exchange of floppy disks as the means of data transport. Basic tools for reading unadorned text representation of the transmission can be built in and used, should all other interfaces fail.

Another advantage of the invention is that it can conform to clinical information technology standards recommended by the Health Level Seven organization (HL7). HL7 is a not-for-profit ANSI-Accredited Standards Developing Organization that provides standards for the exchange, management and integration of data that support clinical patient care and healthcare services. For example, HL7 has proposed a Clinical Document Architecture (CDA), which is a specific embodiment of XML for medical applications. Although HL7 is the prominent standards body, aspects of these standards are still in a state of flux. For example, there are few, if any, recommendations from HL7 regarding genomic information.

A block diagram of an exemplary GMS 100 is shown in FIG. 1. The illustrative system 100 includes a genomic messaging module 110, a receiving module 120, a genomic sequence database 130 and, optionally, a clinical information database 140. Genomic messaging module 110 receives an input sequence from genomic sequence database 130 and, optionally, clinical data from clinical information database 140. Genomic messaging module 110 packages the input data to form an output data stream 150 which is transmitted to a receiving module 120.

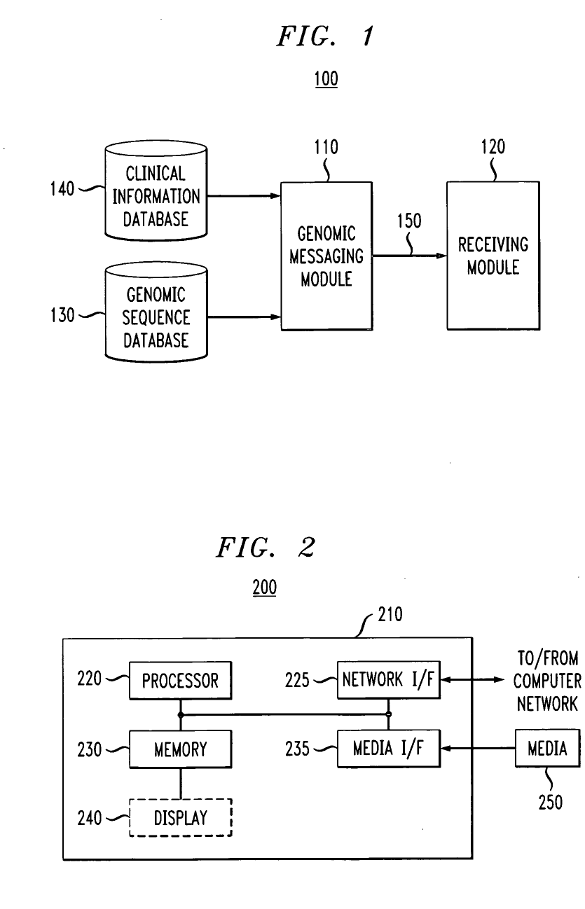

FIG. 2 is a block diagram of a system 200 for deriving a genome of an individual in accordance with one embodiment of the present invention. System 200 comprises a computer system 210 that interacts with a media 250. Computer system 210 comprises a processor 220, a network interface 225, a memory 230, a media interface 235 and an optional display 240. Network interface 225 allows computer system 210 to connect to a network, while media interface 235 allows computer system 210 to interact with media 250, such as a Digital Versatile Disk (DVD) or a hard drive.

As is known in the art, the methods and apparatus discussed herein may be distributed as an article of manufacture that itself comprises a computer-readable medium having computer-readable code means embodied thereon. The computer-readable program code means is operable, in conjunction with a computer system such as computer system 210, to carry out all or some of the steps to perform the methods or create the apparatuses discussed herein. The computer-readable code is configured to access a selector for an individual and a reference template for a group genome, the selector comprising a locus value and a base value; and process the selector and the reference template to derive a sequence representative of the genome of the individual. The computer-readable medium may be a recordable medium (e.g., floppy disks, hard drive, optical disks such as a DVD , or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk.

Memory 230 configures the processor 220 to implement the methods, steps, and functions disclosed herein. The memory 230 could be distributed or local and the processor 220 could be distributed or singular. The memory 230 could be implemented as an electrical, magnetic or optical memory, or any combination of these or other types of storage devices. Moreover, the term “memory” should be construed broadly enough to encompass any information able to be read from or written to an address in the addressable space accessed by processor 220. With this definition, information on a network, accessible through network interface 225, is still within memory 230 because the processor 220 can retrieve the information from the network. It should be noted that each distributed processor that makes up processor 220 generally contains its own addressable memory space. It should also be noted that some or all of computer system 210 can be incorporated into an application-specific or general-use integrated circuit.

Optional video display 240 is any type of video display suitable for interacting with a human user of system 200. Generally, video display 240 is a computer monitor or other similar video display.

It is to be appreciated that, in an alternative embodiment, the invention may be implemented in a network-based implementation, such as, for example, the Internet. The network could alternatively be a private network and/or a local network. It is to be understood that the server may include more than one computer system. That is, one or more of the elements of FIG. 1 may reside on and be executed by their own computer system, e.g., with its own processor and memory. In an alternative configuration, the methodologies of the invention may be performed on a personal computer and output data transmitted directly to a receiving module, such as another personal computer, via a network without any server intervention. The output data can also be transferred without a network. For example, the output data can be transferred by simply downloading the data onto, e.g., a floppy disk, and uploading the data on a receiving module.

The GMS language (GMSL) is a novel “lingua franca” for representing a potentially broad assortment of clinical and genomic data, for secure and compact transmission using the GMS. The data may come from a variety of sources, in different formats, and be destined for use in a wide range of downstream applications. GMSL is optimized for annotation of genomic data.

The primary functions of GMSL include:
retaining such content of the source clinical documents as are required, and combining patient DNA sequences or fragments;
allowing the expert to add annotation to the DNA and clinical data prior to its storage or transmission;
enabling addition of passwords and file protections;
providing tools for levels of reversible and irreversible “scrubbing” (anonymization) of the patient ID etc.;
preventing the addition of erroneous DNA and other lab data to the wrong patient record;
enabling various forms of compression and encryption at various levels, which can be supplemented by standard methods applied to the final file(s);
selecting methods of portrayal of the final information by the receiver, including the choice of what can be seen; and
allowing a special form of XML-compliant “staggered” bracketing to encode DNA and protein features which, unlike valid XML tags, can overlap;

GMSL, like many computer languages, recognizes two basic kinds of elements: instructions (commands) and data. Since GMS is optimized for handling potentially very large DNA or RNA sequences, the structures of these elements are designed to be compact.

A class of commands, relating to a byte mapping principle, allows four bases to be packed into a single byte to give the most compressed stream. This feature is useful for handling long DNA sequences uninterrupted by annotation. The tight packing continues until a special termination sequence of non-DNA characters is encountered. This compressed data can either be transmitted in the main stream, or read from separate files during the decoding process. Another type of command can be used to open or close a “bracket,” like parentheses, for grouping data together. These commands can be used to delineate a particular stretch of a genomic sequence for processing. Unlike parentheses, or markup tags, which can only be “nested,” e.g., {a[b(c)d]e}, GMS brackets can be crossed, e.g., {a[b(c}d)e]. This feature is important for genomic annotation because regions of interest often overlap. It also allows the same part of a sequence, or overlapping parts of sequences, to be processed, e.g., annotated or qualified, in a plurality of ways at the same time.

In addition to these “mixed” commands, there are commands which are not associated with any particular portion of the genomic sequence, as well as commands which are associated with a number of bytes of genomic data. Command codes can be primarily informational. For example, a special command can indicate that a deletion or an insertion of a genomic base, or a run of such bases, occurs at that point.

When sequences are experimentally unreliable at some location in the genomic sequence or it is experimentally unclear whether a particular nucleotide base is, for example, A or G, the sequence can be interrupted by commands indicating that one reliable fragment is ended and that the subsequent fragment has a level of uncertainty. Thus, the ability to keep track of multiple fragments is included within the GMS, including the ability to introduce comments. The GMS has the ability to keep count of the segments and, optionally, separate and annotate them in, for example, in the XML output.

A sample command phrase, or a group made up of several commands, can be as follows:

password;[&7aDfx/b{by shaman protect data];
xml;[<gms:{patient}_dna>\];index;and protein;
filename[template.gms{by shaman unlock data}];read in dna
xml;[</gms:{patient}_dna>\];index;and protein;

Here the command “password” in the command phrase “password;[&7aDfx/b {by shaman protect data],” allows the incoming stream to be read and to be active from that point only if (a) the receiver has already entered a patient ID which encrypts to &7aDfx/b, and (b) if at that point the receiver enters another password, here “shaman.” Data item “filename;[template.gms{by shaman unlock data}]“ allows the data of the file specified to be incorporated into the stream only if that password, here shaman, was the last entered, helping to ensure that the correct file is loaded and to ensure that the field has not been intercepted and falsely continued by a hostile agent. Another password command, with a different password requested, could follow the first password request.

A valuable DNA annotation command is of the example form:
(43
   which forces the tag onto the final XML output file, e.g., <open feature=“whatever” type =“43” level=8/> depending on the bracket level. The command is used to annotate overlapping features, for example, DNA and protein features, which are impermissible to XML (in the sense that to XML <A> <B> </B> </A> is XML -permissible, <A> <B> </A> </B> is not).

Generic DATA statements encode specific or general classes of data which include, for example:

| | |
|---|---|
| data ;[........................./]; | |
| password ;[........................./]; | |
| filename;[........................./]; | |
| number ;[........................./]; | |
| xml;[........................../]; | (XML) |
| perl;[..........................{end of data}] | (Perl applet executed on receipt) |
| hl7;[.............................{end of data}] | (HL7 messages) |
| dicom;[.........................{end of data}] | (images) |
| protein ;[........................./]; | |

squeeze dna;*............................/] (compress DNA to 4 characters
per byte.)

Alternative forms like “data;/ . . . /” are possible. The terminating bracket “]” is optional and is actually a command to parity check the contents of the data statement on receipt. Within the fields “[. . . ” can be inserted text permitted by “type.” Type restriction is currently weak, but backslash would be prohibited in certain types of data to avoid the fact that it is a permissible symbol in content.

A wide variety of commands in curly brackets (often referred to as French braces) can appear in these DATA fields, such as {xml symbols}, {define data}, {recall data}, {on password unlock data}, or carry variable names such as {locus} which are evaluated and macro-substituted into the data only on receipt.

The basic language can be used to make countless phrases out of the combinations, but there are relatively few complex commands formed. For example, the commands

filedata;[{ by shaman unlock data}]
number;[15 base pairs\]
squeeze dna
*
AGCTTCAGAGCTGCT\

place a protective lock on the following data, requiring a password (in this example “shaman”) for access. The commands also compress 15 base pairs of DNA into four base pairs per byte, to the extent possible. Another example is:

name;[mary\];xml;[elizabeth {define data}]
xml;[<test> patient {identifier} has informal code
name {mary}</test>\];index

which illustrates both the use of the use-defined variable “mary” and the system variable “identifier” (the current patient identifier) in writing specifically stated XML (the <test> tags and their content).

The genomic data input file (.gmd) contains the DNA sequences and the optional manual annotation. The DNA sequences are strings of bases. White space is ignored. The annotation is inserted using XML-style tags with a “gms” prefix, but the file is not an XML document.

“Cartridges” as used herein are replaceable program modules which transform input and output in various ways. They may be considered as mini “Expert Systems” in the sense that they script expertise, customizations and preferences. All input cartridges ultimately generate .gms files as the final and main input step. This file is converted to a binary .gmb file and stored or transmitted. Input cartridges include, for example, Legacy Conversion Cartridges, for conversion of legacy clinical and genomic data into GMS language.

When the .gmi file is a CDA document, as might be expected when retrieving data from a modem clinical repository, GMS needs to know how to convert the content, marked up with CDA tags, into the required canonical .gms form. This is accomplished using a GMS “cartridge.” In this scenario representing the first GMS cartridge application supporting automation, the expert optionally modifies a file obtained in CDA format to include additional annotation and structure. Again, the template mode described above is available to help guide this process so that the whole modified document remains CDA compliant. The resulting CDA document with added genomic features represents a “CDA Genomics Document.” Such a CDA document can now be automatically converted into GMSL. In addition to the legacy record conversion cartridge described above, automatic addition of genomic data is also contemplated by the invention so that the CDA Genomics Document is itself automatically generated from the initial CDA genomics-free file.

For example, genomic data can be merged using a gms: namespace prefix at the end of the CDA <body>, in its own CDA <section> as shown below using CDA structure:

```
<cda:clinical_document_header>
      .
      .<!--header structures per CDA-->
      .
</cda:clinical_document_header>
<cda:body>
      .
      .<!--clinical sections per CDA-->
      .
      <cda:section>
            <cda:caption>
                  IBM Genomic Messaging System Data
            </cda:caption>
            <cda:paragraph>
                  <cda:content>
                        <cda:local_markup ignore=“markup”>
                              <!--gms: tags go here-->
                        </cda:local_markup>
                  </cda:content>
            </cda:paragraph>
      </cda:section>
</cda:body>
```

More precisely, the cartridge looks first to see if the tags already exist in the document, in which case the cartridge will keep the tags. If the tags are missing, the cartridge will look for a <gms:body or <body tag (case-insensitively). If, however, there is no body tag, the cartridge will insert a <gms:body or <body tag (case-insensitively) before the last tag in the document. More information on GMS and the processing of data including a genomic sequence is discussed in U.S. patent application Ser. No. 10/185,657, filed Jun. 28, 2002, entitled “Genomic Messaging System,” incorporated herein by reference.

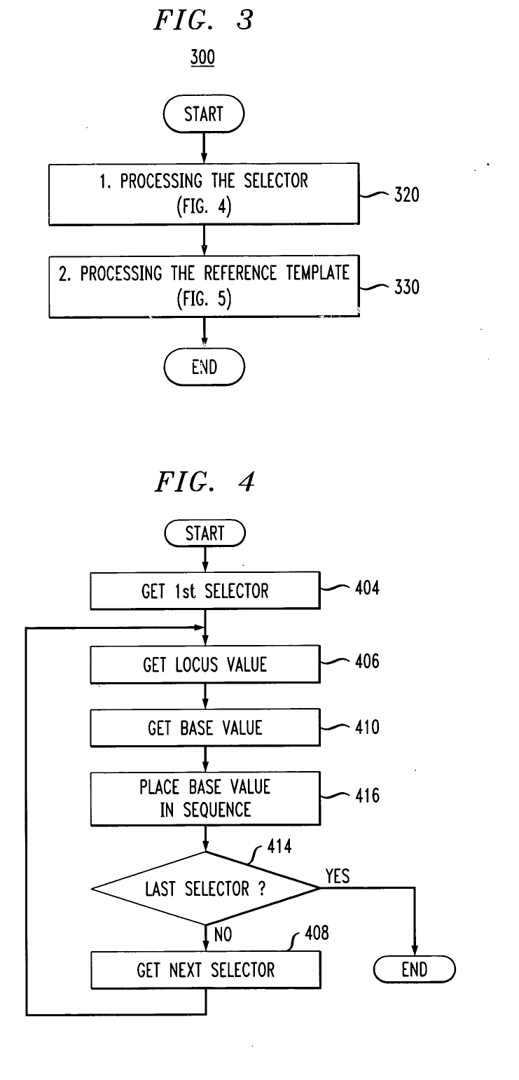

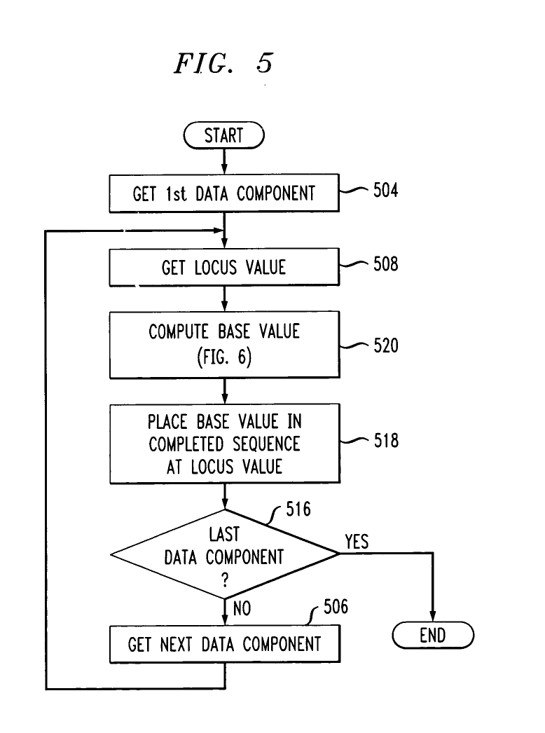

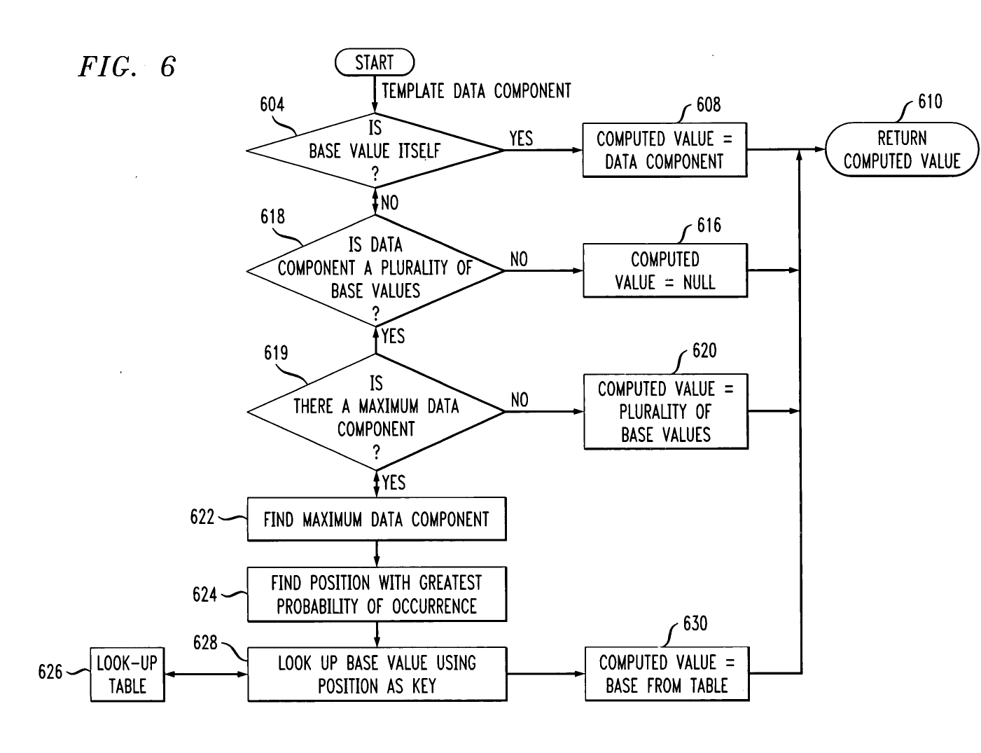

FIG. 3 is a flow chart describing an exemplary method 300 for deriving a genome of an individual. As shown in FIG. 3, the method 300 includes a step 320 for processing a selector and a step 330 for processing a reference template. Each step will be discussed in more detail below, in conjunction with FIGS. 4 and 5, respectively.

FIG. 4 is a flow chart describing the step 320 (FIG. 3) of processing a selector in further detail. As is shown in FIG. 4, processing a selector includes a step 404 to obtain a selector. Once a selector is obtained, step 406 includes determining a locus value and step 410 includes determining a base value. The locus value represents a position in a nucleotide sequence. The base value represents a nucleotide base. Preferred nucleotide bases include, but are not limited to, the purines: adenine (A) and guanine (G), and the pyrimidines: cytosine (C) and thymine (T) or uracil (U) (i.e., uracil in RNA). For example, a selector that includes the base value and locus value of, e.g., (A,6), indicates that at the sixth position in the nucleotide sequence, the nucleotide base adenine is present.

From the base value and the locus value, the appropriate base value is placed in a sequence representative of the genome of the individual, as is shown in step 416. The sequence representative of the genome of the individual is a nucleotide sequence derived by processing the selector and the reference template (as will be described in more detail below, in conjunction with FIG. 5). In the example set forth above, wherein the selector includes the base value and the locus value (A,6), an adenine would be placed in the sixth position in the sequence representative of the genome of the individual.

As shown in step 414, the processing of selectors is continued until no more selectors remain, as detected during step 408.

In a preferred embodiment, the base value and the locus value, or base values and locus values, included in the selector, represent polymorphisms. Polymorphisms may be defined as variable regions of a genome that are stabilized in a population (i.e., typically occurring in at least 1% of the individuals in the population, as opposed to individualized random mutations). Additionally, the base values and locus values may represent areas of the genome that are of particular interest. Exemplary areas of interest include areas of the genome encoding a certain protein, or group of proteins.

Representing the genome of an individual by selectors comprising base values and locus values representing, i.e., polymorphisms, areas of interest, or both, allows for only the essential genomic data of the individual to be transmitted. The transmitted data can then be reconciled with the reference template on a receiving end of, e.g., the GMS. Thus, a more efficient and accurate transfer of genomic data may be achieved.

The reference template is then processed. The reference template is a nucleotide sequence representative of a group genome. The term “group” is used to describe any population, sub-population, or grouping of individuals. Preferably, the group is a sub-population. Suitable sub-populations for use in the present invention may be defined by several parameters, including but not limited to, race, ethnic group, tribe, clan, family and sibling group. The methods of the present invention may be used to determine representative nucleotide sequences for each sub-population considered to be a group. By grouping individuals into sub-populations, more universal genomic characteristics, such as the pilot regions of a peptide and intron regions of a gene, as well as more polymorphic protein characteristics such as glycosylation, are recognized.

FIG. 5 is a flow chart describing the step 330 (FIG. 3) of processing a reference template. As shown in FIG. 5, processing of the reference template includes a step 504 to obtain a data component. The data component comprises a locus value and a base value, or plurality of base values, as will be described in more detail below. Once a data component is obtained, step 508 includes determining a locus value. The locus value is determined for positions in the sequence representative of the genome of the individual not included in the selector. Thus, in the example highlighted above, wherein the selector has the base value and the locus value (A,6), an adenine would already have been placed in the sixth position of the sequence representative of the genome of the individual, and therefore, a locus value would need not be determined from the reference template for the sixth nucleotide position.

Once the locus value has been determined from the reference template, in step 508, the base value is then computed, as shown in step 520. This step will be discussed in more detail below, in conjunction with FIG. 6. From the determined locus value and the computed base value, the appropriate base value is placed in the sequence representative of the genome of the individual, as shown in step 518. As shown in step 516, the processing of the reference template is continued. The reference template is processed until no data components remain, i.e., as detected during step 506.

FIG. 6 is a flow chart describing the step 520 (FIG. 5) of computing the base value. The data components included in the reference template represent locus values and base values in the group genome. The data components may represent a single base value, as shown in step 604, or a plurality of base values, as shown in step 618. When the data component represents a single base value, as shown in step 608, then the computed base value would be presented, as in step 610, and placed in the sequence representative of the genome of the individual at the determined locus value. When the data component represents a plurality of base values, as shown in step 618, it needs to be determined whether there is a maximum data component, as shown in step 619. The maximum data component may be defined as the data component with the highest value. If no maximum data component exists then a plurality of base values, as shown in step 620, would be presented, as in step 610, and placed in the sequence representative of the genome of the individual at the determined locus value. The situation wherein no maximum data component exists will be discussed in more detail below. If a maximum data component exists, then it needs to be determined, as shown in step 622. If the data component represents neither a single base value, nor a plurality of base values, as in step 616, then the data component is null and the process is repeated for that position.

A data component representing a plurality of base values arises, for example, when there are a plurality of base values represented at that particular locus value in the group genome. In this instance, the data component represents the probability of occurrence of a particular base value at that locus value, i.e., the probability that one of adenine, cytosine, guanine or thymine will occur, based on the occurrences of adenine, cytosine, guanine and thymine at corresponding positions in the group genome. The corresponding positions in the group genome represent one single position present in a plurality of the sequences that comprise the group genome. For example, in the following reference template:

. . . (40, 30, 10, 20) (20, 20, 60) (50, 10, 40) (33, 33, 34) (90, 5, 5) . . .

Each bracketed set of values displayed represents the probability of occurrence of a particular base value at that particular position in the group genome. In the example immediately above, the probability of occurrence is represented as a percentage of the group genome that has the particular base value in corresponding positions. Thus, for example, if the first bracketed set of values represents the probability of occurrence for adenine, cytosine, guanine and thymine, respectively, then 40% of the group has adenine at that position, 30% have cytosine, 10% have guanine and 20% have thymine. Additionally, the four remaining bracketed values shown indicate that one of the four DNA base values is not present at that position (i.e., the three probability of occurrence values shown total 100%). A detailed description of a reference template including probability of occurrence values appears in U.S. patent application Ser. No. ______, filed contemporaneously herewith, entitled “Method and Apparatus for Deriving a Representative Nucleotide Sequence for Expressing a Group Genome,” (Attorney Docket Number YOR920010649US1) incorporated herein by reference.

To determine a maximum data component, as in step 622, the greatest probability of occurrence represented by the data component is determined, as shown in step 624. The base value corresponding to that greatest probability of occurrence is then placed into the sequence representative of the genome of the individual at the determined locus value.

A look-up table may be employed to determine the base value that corresponds to the highest probability of occurrence, as shown in steps 628 and 626. A look-up table indicates which base value corresponds to which probability of occurrence, by indicating the position of the probability of occurrence value, i.e., in the bracketed set of values. An exemplary look-up table might read:

| Position | Base Value |
|---|---|
| 1 | A |
| 2 | C |
| 3 | G |
| 4 | T |

Thus, in the table above, the first probability of occurrence value represents adenine, the second probability of occurrence value represents cytosine, the third probability of occurrence value represents guanine and the fourth probability of occurrence value represents thymine. As such, for the first bracket set of values displayed above . . . (40, 30, 10, 20) . . . , the use of the look-up table would reveal:

| Position | Example | Base Value |
|---|---|---|
| 1 | 40 | A |
| 2 | 30 | C |
| 3 | 10 | G |
| 4 | 20 | T |

Additionally, the probability of occurrence values may be presented consistently throughout the reference template. For example, the first value presented always corresponds to the probability of occurrence of adenine, the second value always corresponds to the probability of occurrence of cytosine, the third value always corresponds to the probability of occurrence of guanine and the fourth value always corresponds to probability of occurrence of thymine.

Preferably, the probability of occurrence values for three of four possible base values are presented, and the probability of occurrence for the fourth base value is derived as a 100% probability of occurrence less the sum of the probability of occurrence of the other three base values.

The situation wherein there is no maximum data component arises when there are positions in the sequence representative of the genome of the individual not included in the selector, and wherein the reference template includes data components representing the probability of occurrence for a plurality of base values but there is no maximum data component (e.g., two or more base values have the same probability of occurrence). Such is the case when, e.g., the reference template includes the data components, (40, 40, 10, 10). In this instance, it is preferable to place the data components representative of the plurality of data values into the sequence. Thus, multiple base values will be represented at that position in the sequence.

### EXAMPLE

The following are exemplary selectors and an exemplary reference template. The reference template includes a locus value, and data components. Some data components represent a single base value, and some data components represent a plurality of base values. The selectors include base values and locus values.

locus

| 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|
| A | G | 50, 30, 10 | C | T | 0, 20, 80 | A | 40, 0, 0 | G | C | 0, 40, 60 | C | 40, 0, 60 | G | G |

The individual selector is represented as: (C,6,) (A,8,) The sequence representative of the genome of the individual can be computed using the following algorithm:

For each locus in the template:
If the value at this locus is a single base, copy that value to the results sequence at the same locus.
If the value at this locus is a plurality of values, look in the selector for a (locus value/base value) pair which matches this locus:
   If found, copy the base from the selector to the same locus.

Otherwise, find the maximum data component in the mixture, and copy the base value corresponding to the position of that value in the plurality of values according to the established convention (i.e., look-up table). For this example, the look-up table is:

| Position | Base Value |
|---|---|
| 1 | A |
| 2 | C |
| 3 | G |
| 4 | T |

The sequence representative of the genome of the individual would read as follows:

| | | | | | | | | | | | | | | |
|---|---|---|---|---|---|---|---|---|---|---|---|---|---|---|
| 1 | 2 | 3 | 4 | 5 | 6 | 7 | 8 | 9 | 10 | 11 | 12 | 13 | 14 | 15 |
| A | G | A | C | T | C | A | A | G | C | G | C | G | G | G |

Although illustrative embodiments of the present invention have been described herein, it is to be understood that the invention is not limited to those precise embodiments, and that various other changes and modifications may be effected therein by one skilled in the art without departing from the scope or spirit of the invention. The following examples are provided to illustrate the scope and spirit of the present invention. Because these examples are given for illustrative purposes only, the invention embodied therein should not be limited thereto.

What is claimed is:

1. A method for deriving a genome of an individual, comprising the steps of:
accessing a selector for an individual and a reference template for a group genome, the selector comprising a locus value and a base value; and
processing the selector and the reference template to derive a sequence representative of the genome of the individual.

2. The method of claim 1, wherein the locus value represents a position in a nucleotide sequence.

3. The method of claim 1, wherein the base value represents a nucleotide base.

4. The method of claim 1, wherein the selector comprises a plurality of locus values and a plurality of base values.

5. The method of claim 1, wherein the reference template comprises data components representing a base value.

6. The method of claim 5, wherein the data components represent a probability of occurrence for the base value.

7. The method of claim 6, wherein the probability of occurrence is based on base value occurrences at corresponding locus values in the group genome.

8. The method of claim 7, further comprising:
computing a base value from the data component in the reference template, for base values not in the selector.

9. The method of claim 8, further comprising the step of:
finding a maximum data component.

10. The method of claim 8, wherein the computed base value comprises a plurality of base values.

11. The method of claim 9, wherein the maximum data component represents a greatest probability of occurrence.

12. The method of claim 9, wherein finding the maximum component includes use of a mixture table.

13. A system comprising:
a memory that stores computer-readable code; and
a processor operatively coupled to the memory, the processor configured to implement the computer-readable code, the computer-readable code configured to:
access a reference template for a group genome and a selector for an individual, the selector comprising a locus value and a base value; and
process the reference template and the selector to derive a sequence representative of the genome of the individual.

14. The system of claim 13, wherein the reference template comprises data components representing a probability of occurrence of a base value.

15. The system of claim 14, wherein the probability of occurrence is based on base value occurrences at corresponding locus values in the group genome.

16. The system of claim 14, wherein the computer-readable code is further configured to:
compute a base value from the data component in the reference template, for base values not in the selector.

17. An article of manufacture comprising:
a computer-readable medium having computer-readable code embodied thereon, the computer-readable code comprising:
a step to access a reference template for a group genome and a selector for an individual, the selector comprising a locus value and a base value; and
a step to process the reference template and the selector to derive a sequence representative of the genome of the individual.

18. The article of manufacture of claim 17, wherein the reference template comprises data components representing a probability of occurrence of a base value.

19. The article of manufacture of claim 18, wherein the probability of occurrence is based on base value occurrences at corresponding locus values in the group genome.

20. The article of manufacture of claim 18, wherein the computer-readable code further comprises:
a step to compute a base value from the data component in the reference template, for base values not in the selector.


SEQUENCE LISTING (3 sequences)

SEQ ID NO: 1 - DNA, 15 bp, Homo sapiens
agcttcagagctgct

SEQ ID NO: 2 - DNA, 15 bp, Homo sapiens
  misc_feature (3)..(3): n is a, c, g, or t
agnctsawgcscrgg

SEQ ID NO: 3 - DNA, 15 bp, Homo sapiens
agactcaagcgcggg